(19) United States
(12) Patent Application Publication
(10) Pub. No.: US 2016/0153861 A1
(43) Pub. Date: Jun. 2, 2016

(54) DEVICE FOR DETECTING THE COMBUTION CHAMBER PRESSURE IN AN INTERNAL COMBUSTION ENGINE

(71) Applicant: ROBERT BOSCH GMBH, Stuttgart (DE)

(72) Inventors: Christian Doering, Stuttgart (DE); Remigius Has, Grafenau-Daetzingen (DE)

(21) Appl. No.: 14/901,550

(22) PCT Filed: Jun. 20, 2014
(86) PCT No.: PCT/EP2014/063010

§ 371 Date: Dec. 28, 2015

(30) Foreign Application Priority Data
Jun. 27, 2013 (DE) 10 2013 212 468.6

(51) Int. Cl. G01L 23/14

(52) U.S. Cl. CPC G01L 23/14

(57) ABSTRACT

A combustion chamber pressure sensor in an engine mounting component is provided, the combustion chamber pressure sensor including a sensor carrier which is accommodated in a housing. In addition, a pressure sensor element including a diaphragm is provided at an end of the sensor carrier facing the combustion chamber. The pressure sensor element includes an eddy current sensor, which includes at least one first solenoid coil.

### FIELD OF THE INVENTION

The present invention relates to a device for detecting the combustion chamber pressure in an internal combustion engine.

### BACKGROUND INFORMATION

The pressure profile in the cylinder of an internal combustion engine is usually detected by a combustion chamber pressure sensor. The progression of the combustion taking place in the cylinder may be evaluated by using this sensor. A distinction is usually made between a combustion chamber pressure sensor, which carries out measurements directly, and one which carries out measurements indirectly. In the combustion chamber pressure sensor carrying out measurements directly, the sensor element is exposed directly to the combustion chamber atmosphere. For this purpose, the combustion chamber pressure sensor is configured in such a way that it is still capable of functioning even at temperatures around 600° C.

A combustion chamber pressure sensor, which carries out measurements indirectly, is integrated into a sparkplug or a glow plug or a fuel injector, the sensor element being situated a further distance away from the combustion chamber, so that the thermal load acting on the combustion chamber pressure sensor carrying out measurements indirectly is lower.

Patent document DE 196 80 912 C2 discusses a device for detecting the cylinder pressure in an auto-igniting internal combustion engine. The device includes a pressure sensor having a heating section of a glow plug, which faces an interior space of the cylinder of the auto-igniting internal combustion engine and may be acted upon by the cylinder pressure. In addition, a fixing element is provided for fixing the heating section in a body of the glow plug. The pressure sensor is situated between the heating section and the fixing element in the glow plug. The heating section is configured for transferring the cylinder pressure to the pressure sensor. A power supply terminal of the glow plug is connectable to a power source for heating the heating section, and an output signal of the pressure sensor may be picked up via the power supply terminal when the power supply terminal is disconnected from the power source.

Patent document DE 10 2005 026 074 A1 relates to a sheathed-element glow plug including an integrated combustion chamber pressure sensor. To permit efficient and low-emission engine control, a piece of information about the combustion chamber pressure in the combustion chamber of an internal combustion engine is needed. Therefore, according to DE 10 2005 026 074 A1, an integrated combustion chamber pressure sensor in the form of a sheathed-element glow plug for an auto-igniting internal combustion engine is provided. The sheathed-element glow plug has a heating element and a plug housing. In addition, the sheathed-element glow plug has at least one force-measuring film element, the at least one force-measuring film element being connected to the heating element in such a way that a force is transferable to the at least one force-measuring film element via the heating element. The at least one force measuring film element may in particular have at least one piezoelectric film, for example, a piezoelectric film of a highly polarized polyvinylidene fluoride (PVDF).

### SUMMARY OF THE INVENTION

The present invention is based on the object of integrating a sensor element of a combustion chamber pressure sensor and the associated electronic evaluation system into a glow plug, a fuel injector or a sparkplug and enabling thermal separation of the combustion chamber from the pressure sensor element by noncontact evaluation.

According to the present invention, a device for detecting the combustion chamber pressure in the cylinder of an internal combustion engine is provided, in which an eddy current sensor is positioned behind a diaphragm, which functions as a sealing element, the diaphragm being deformed under the influence of the combustion chamber pressure prevailing in the cylinder. The thermal separation of an eddy current sensor from the temperature level prevailing in the combustion chamber of an internal combustion engine, for example, is therefore ensured. In addition, a complex accessory and connecting technology may be omitted in comparison with approaches in which silicon strain gauges are applied to a stainless steel diaphragm with the aid of a low-melting glass solder.

Using the approach provided according to the present invention, deformation of a diaphragm under the influence of the combustion chamber pressure is detectable by an eddy current measurement in a noncontact operation.

If the integrated combustion chamber pressure sensor provided according to the present invention is integrated into a glow plug, for example, which is associated with the cylinders of an auto-igniting internal combustion engine, then various coil shapes may be advantageous in the design of a coil used for detecting the pressure. A coil here is understood to be a coil which generates a magnetic field. According to the present invention, the coil shapes may be characterized by a round or rectangular geometry, for example; but more complex coil shapes may also be used advantageously. For example, the coil may have a planar shape. In a specific embodiment of the present invention, a plurality of coils is situated in the form of a ring. Furthermore, in a specific embodiment of the present invention, the at least one first coil may also be provided in multiple levels situated one upon another.

In one specific embodiment of the present invention, the diaphragm is constructed in layers, at least the side of the diaphragm facing the at least one coil being configured to be electrically conductive. Such a design makes it possible to make metrological use of an eddy current effect occurring on the side facing the coil, while reducing the inductance at the same time. Furthermore, the diaphragm has a minimum thickness to take the skin effect into account during the frequency evaluation.

Alternatively, the diaphragm may be manufactured from a ferromagnetic material which has a high magnetic permeability μᵣ. The magnetic field is focused in the approach of a diaphragm made of a ferromagnetic material having a high magnetic permeability to the at least one coil, resulting in an elevated inductance.

In another possible embodiment of the idea underlying the present invention, the integrated combustion chamber pressure sensor, which is integrated into a glow plug for an auto-igniting internal combustion engine, for example, may have a first coil and a second coil for distance detection. The second coil is used for distance detection of the metallic base body and thus for compensation of interfering influences, which may occur due to changes in distance as a result of temperature changes for example. In addition, there is the option of situating multiple planar coils opposite the diaphragm instead of only one coil, so that a deflection of the diaphragm by multiple solenoid coils may be read out simultaneously, thereby yielding a redundant sensor signal.

The combustion chamber pressure sensor provided according to the present invention may be manufactured directly on a circuit board. Alternatively, a micromechanical manufacturing method using silicon is also conceivable. When using circuit boards, cost advantages are achievable in comparison with micromechanical manufacturing methods using silicone. When the combustion chamber pressure sensor units are manufactured directly on a circuit board, this manufacturing method may also make it possible to manufacture the coils in a larger size, i.e., up to a diameter of one centimeter or more. Various coil shapes may be advantageous in the design of the shape of the coils, for example, a round geometry or a rectangular geometry. More complex coil shapes are also conceivable.

The at least one coil may also be applied to a ceramic substrate, which is characterized by a high corrosion resistance and thermal stability.

An important advantage of the approach according to the present invention is that it is possible to omit contact between the coil and the conductive surface on the diaphragm, whose position is detected. The conductive surface is acted upon by the pressures and temperatures prevailing in the combustion chamber, while a thermal and mechanical decoupling between the coil and the diaphragm is achieved due to the omission of electrical contact. The design of the combustion chamber pressure sensor according to the present invention is particularly simple and allows an efficient and inexpensive assembly.

Furthermore, the combustion chamber pressure sensor according to the present invention may easily be provided with a plurality of coils. In this way, the combustion chamber pressure sensor according to the present invention has a redundant design, so that multiple measurements may be carried out easily in parallel. Carrying out multiple parallel measurements makes it possible to reliably achieve precise measuring results. In addition, a redundant design ensures a high error tolerance and failure tolerance of the combustion chamber pressure sensor according to the present invention. Failure of one coil from a plurality of coils does not result in failure of the combustion chamber pressure sensor.

The present invention is described in greater detail below on the basis of the drawings.

### BRIEF DESCRIPTION OF THE DRAWINGS

FIG. 1 shows an engine mounting component including a combustion chamber pressure sensor according to the present invention.

FIG. 2 schematically shows a first specific embodiment of the combustion chamber pressure sensor according to the present invention in cross section.

FIG. 3 shows a top view of a first specific embodiment of a solenoid coil.

FIG. 4 shows a top view of a second specific embodiment of a solenoid coil.

FIG. 5.1 schematically shows a second specific embodiment of the combustion chamber pressure sensor according to the present invention in cross section.

FIG. 5.2 shows a detailed schematic view of a pressure sensor element in cross section.

FIG. 6.1 shows a third specific embodiment of the combustion chamber pressure sensor according to the present invention in cross section.

FIG. 6.2 schematically shows a top view of a solenoid coil arrangement.

FIG. 7 shows an arrangement of solenoid coils in a fourth specific embodiment of the combustion chamber pressure sensor according to the present invention.

FIG. 8.1 shows a first arrangement of multiple first coils according to the present invention.

FIG. 8.2 shows a second arrangement of multiple first coils according to the present invention.

### DETAILED DESCRIPTION

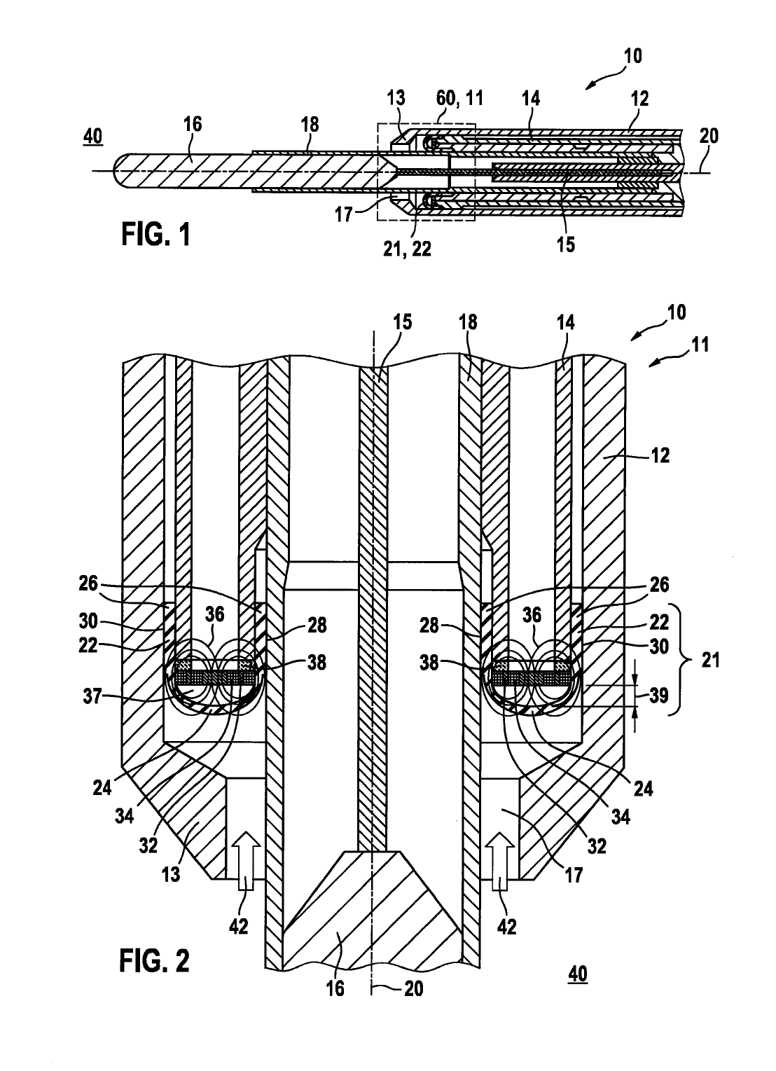

FIG. 1 shows an engine mounting component 10 in cross section, which is provided with a combustion chamber pressure sensor 11 according to the present invention. A sleeve 18, in which a heating element 16 is situated, is accommodated centrally along a main axis 20 in an essentially cylindrical housing 12. Heating element 16 extends into a combustion chamber 40. In addition, a sensor carrier 14 is accommodated in housing 12. A pressure sensor element 21, which includes a circumferential diaphragm 22, is situated at the combustion chamber-side end of this sensor carrier. Furthermore, housing 12 has an end facing the combustion chamber in the form of a cone 13, through which sleeve 18 including heating element 16 extends essentially centrally. A circumferential opening 17 which ensures a passage of gas from combustion chamber 40 to diaphragm 22 is provided between sleeve 18 and cone 13. Diaphragm 22 ensures a seal between sleeve 18 and housing 12. The pressure in combustion chamber 40 is measured by combustion chamber pressure sensor 11 according to the present invention, which is situated in area 60, which is delineated by broken lines. Area 60, which is delineated by broken lines, is shown in detail in FIG. 2.

FIG. 2 shows a first specific embodiment of combustion chamber pressure sensor 11 according to the present invention in detail. Combustion chamber pressure sensor 11 according to the present invention is mounted in an engine mounting component 10, which includes an essentially cylindrical housing 12. A sleeve 18, which is accommodated along a main axis 20 in housing 12, has a heating element 16 mounted in it. Moreover, a sensor carrier 14 is accommodated between housing 12 and sleeve 18. Furthermore, circumferential diaphragm 22, which has an essentially U-shaped cross section, is attached to the end of sensor carrier 14 facing the combustion chamber. The cross section of diaphragm 22 includes a measuring section 24 which is positioned between two fastening sections 26. Fastening sections 26 are clamped securely between sleeve 18 and sensor carrier 14 or between sensor carrier 14 and housing 12. Measuring section 24 surrounds the end of sensor carrier 14 facing the combustion chamber in the form of an arc. A fastening section 26 on the lateral surface of sleeve 18 forms a circumferential first sealing surface 28 due to a compression between sensor carrier 14 and sleeve 18. Furthermore, a radially exterior fastening section 26 of diaphragm 22 forms a second circumferential sealing surface 30 due to compression on the inside of housing 12. First and second sealing surfaces 28, 30 each form a pressure-tight connection which is established by laser welding.

Housing 12 has a cone 13 at the end facing the combustion chamber, sleeve 18 extending along main axis 20 through this cone. A circumferential opening 17 provided between sleeve 18 and cone 13 allows a passage of gas from combustion chamber 40 to circumferential diaphragm 22.

Furthermore, at the end of sensor carrier 14 facing the combustion chamber, a substrate 38 made of a ceramic material is accommodated to which an eddy current sensor 32 is attached which includes a first coil 34. U-shaped diaphragm 22 surrounds first coil 34 in the form of an arc, a cavity 37 being provided between first coil 34 and measuring section 24 of diaphragm 22. Cavity 37 has a clearance 39, which allows deformation of measuring section 24.

Furthermore, combustion chamber 40 is exposed to pressures, so that a compressive force 42 acts on measuring section 24 of diaphragm 22. A change in clearance 39 between first coil 34 and diaphragm 22 which occurs due to compressive force 42 is detected by first coil 34. Diaphragm 22 is configured in such a way that a movement of measuring section 24 induces an interaction with a magnetic field 36 which is generated by first coil 34. Eddy currents then occur and are detected for a noncontact distance measurement between first coil 34 and measuring section 24. On the whole, this arrangement of first coil 34 with diaphragm 22 implements the principle of an eddy current sensor.

Furthermore, first coil 34 is situated on ceramic substrate 38, which ensures thermal decoupling between sensor carrier 14 and eddy current sensor 32.

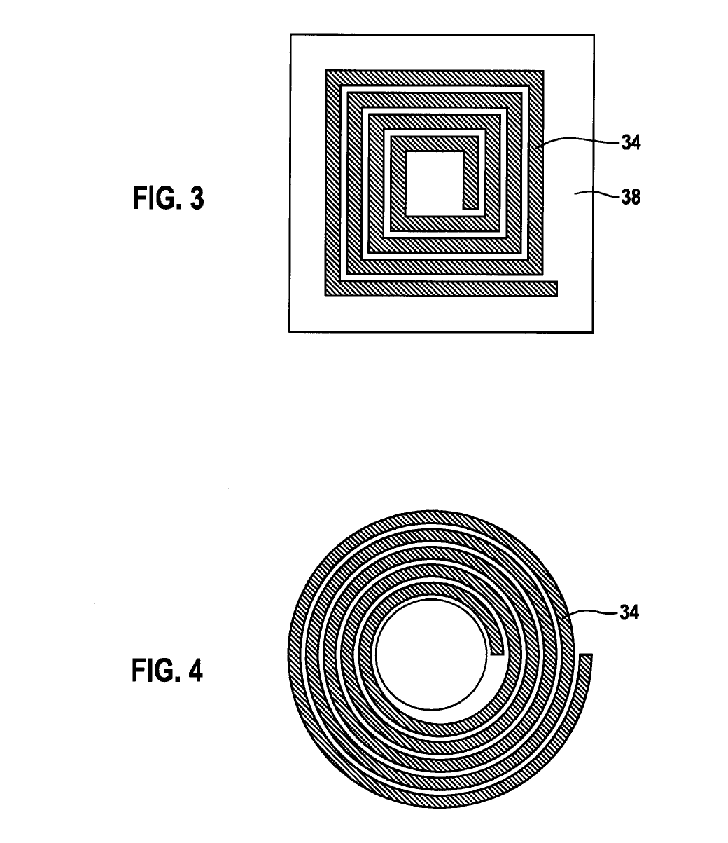

FIG. 3 shows a schematic top view of a first specific embodiment of first coil 34 which is situated on substrate 38. First coil 34 is configured to be essentially rectangular. A plurality of first coils 34 according to FIG. 3 may be situated, for example, in the form of a ring around a sleeve 18 (not shown). Furthermore, FIG. 4 shows a second specific embodiment of first coil 34, which is configured essentially in the form of a circle or a spiral. First coil 34 according to FIG. 4 may be situated circumferentially around a sleeve 18 (not shown) or a plurality of such first solenoid coils 34 may be situated in the form of a ring or circumferentially around sleeve 18.

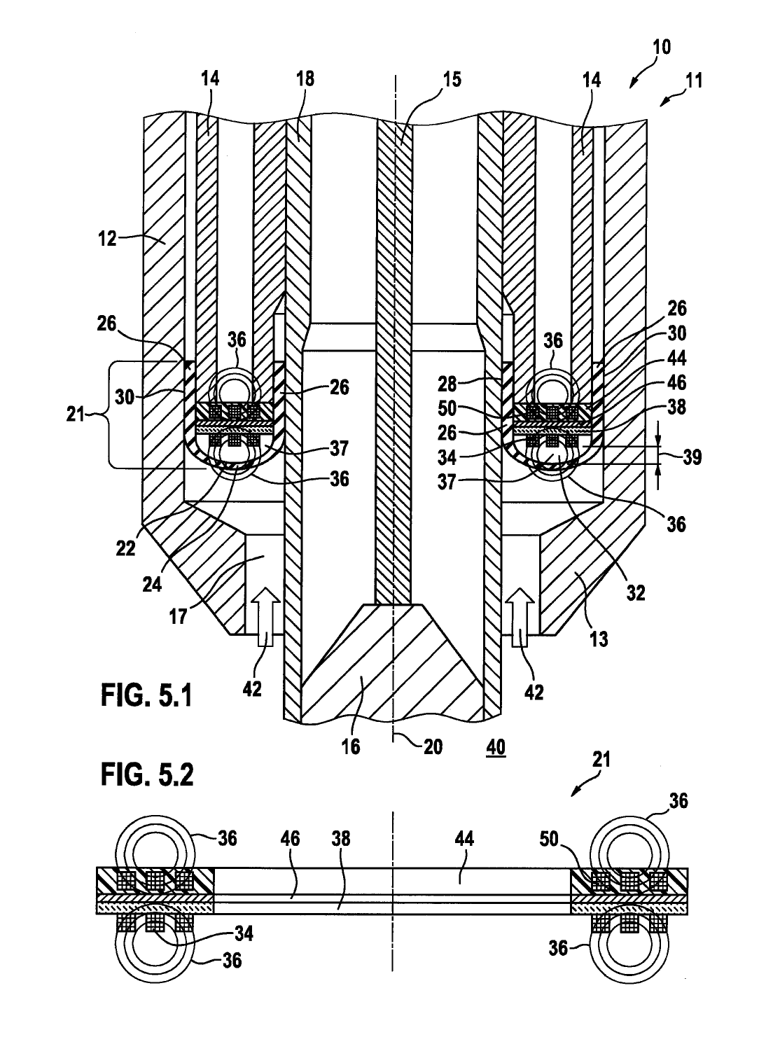

FIG. 5.1 schematically shows a cross section through a second specific embodiment of combustion chamber pressure sensor 11 provided according to the present invention. Combustion chamber pressure sensor 11 according to the present invention is mounted in an engine mounting component 10, which includes an essentially cylindrical housing 12. A sleeve 18, in which a heating element 16 is mounted, is accommodated along a main axis 20 in housing 12. Furthermore, a sensor carrier 14 is accommodated between housing 12 and sleeve 18. In addition, a diaphragm 22 having an essentially U-shaped cross section is fastened at the end of sensor carrier 14 facing the combustion chamber. The cross section of diaphragm 22 includes a measuring section 24, which is positioned between two fastening sections 26. Fastening sections 26 are securely clamped in the radial direction between sleeve 18 and sensor carrier 14 or between sensor carrier 14 and housing 12. Measuring section 24 surrounds the end of sensor carrier 14 facing the combustion chamber in the form of an arc. A fastening section 26 on the lateral surface of sleeve 18 forms a circumferential first sealing surface 28 due to a compression between sensor carrier 14 and sleeve 18. Furthermore, a radially exterior fastening section 26 of diaphragm 22 forms a circumferential second sealing surface 30 due to compression on the inside of housing 12. First and second sealing surfaces 28, 30 each represent a pressure-tight connection which is established by laser welding.

At the end facing the combustion chamber, housing 12 has a cone 13 through which sleeve 18 extends along main axis 20. A circumferential opening 17 provided between sleeve 18 and cone 13 allows a passage of gas from the combustion chamber to diaphragm 22.

Furthermore, at the end of sensor carrier 14 facing the combustion chamber, a ceramic substrate 38 is accommodated, to which an eddy current sensor 32 including a first coil 34 is fastened. U-shaped diaphragm 22 surrounds first coil 34 in the form of an arc, a cavity 37 being formed between first coil 34 and measuring section 24 of diaphragm 22. The cavity has a clearance 37, which allows deformation of measuring section 24 of diaphragm 22.

Furthermore, pressures and pressure fluctuations, which cause a compressive force 42 which acts upon measuring section 24 of diaphragm 22, occur in combustion chamber 40. As a result of compressive force 42, a change in the clearance between coil 34 and diaphragm 22 occurs, which is detected by first coil 34. Diaphragm 22 is manufactured from an electrically conductive material, so that a deformation of measuring section 24 occurs due to an interaction with magnetic field 36, generated by first coil 34. Eddy currents then occur and are detected for a noncontact distance measurement between first coil 34 and measuring section 24. On the whole, the arrangement of first coil 34 with diaphragm 22 implements the principle of an eddy current sensor.

Furthermore, first coil 34 is mounted on a side of a circuit board 44 facing the combustion chamber, in which a second coil 50 is accommodated. First coil 34 and second coil 50 are situated axially one after another along main axis 20. A separating layer 46 is provided between first coil 34 and second coil 50 within circuit board 44. Separating layer 46 is manufactured from an electrically conductive material, for example, copper, and separates magnetic fields 36 which are generated by first and second coils 34, 50. This prevents an interaction between magnetic fields 36 of first and second coils 34, 50.

Second coil 50 implements the principle of an eddy current sensor, which measures a distance between second coil 50 and sensor carrier 14. Different temperatures on housing 12, sensor carrier 14, sleeve 18 and diaphragm 22 result in thermal stresses in the corresponding components, causing a change in clearance 39 of cavity 37. Without extensive technical measures, such changes in clearance 39 of cavity 37 result in accurate measurements with the aid of first coil 34 no longer being possible. Axial displacements of circuit board 44 are detected with the aid of second coil 50. Based on the measured values of second coil 50, the measured values of first coil 34 are corrected, so that the pressure prevailing in combustion chamber 40 is detected accurately.

In addition, FIG. 5.2 shows a detailed representation of the arrangement of first coil 34 and second coil 50 on circuit board 44. First coil 34 is mounted on a side of circuit board 44 facing the combustion chamber, and second coil 50 is accommodated within circuit board 44. A separating layer 46 is mounted between first coil 34 and second coil 50. Separating layer 46 is manufactured from a conductive material, for example, copper, and prevents interference of magnetic fields 36 of first coil 34 and second coil 50. Second coil 50 also implements the principle of an eddy current sensor, with which the distance between second coil 50 and sensor carrier 14 is detected. Thermally induced expansions, which occur in the area of pressure sensor element 21 and which impair the measurements with the aid of first coil 34, may be compensated on the basis of the distance changes detected with the aid of second coil 50. The design according to FIG. 5.2 makes it possible to carry out an accurate contact-free pressure measurement in combustion chamber 40 under varying thermal conditions.

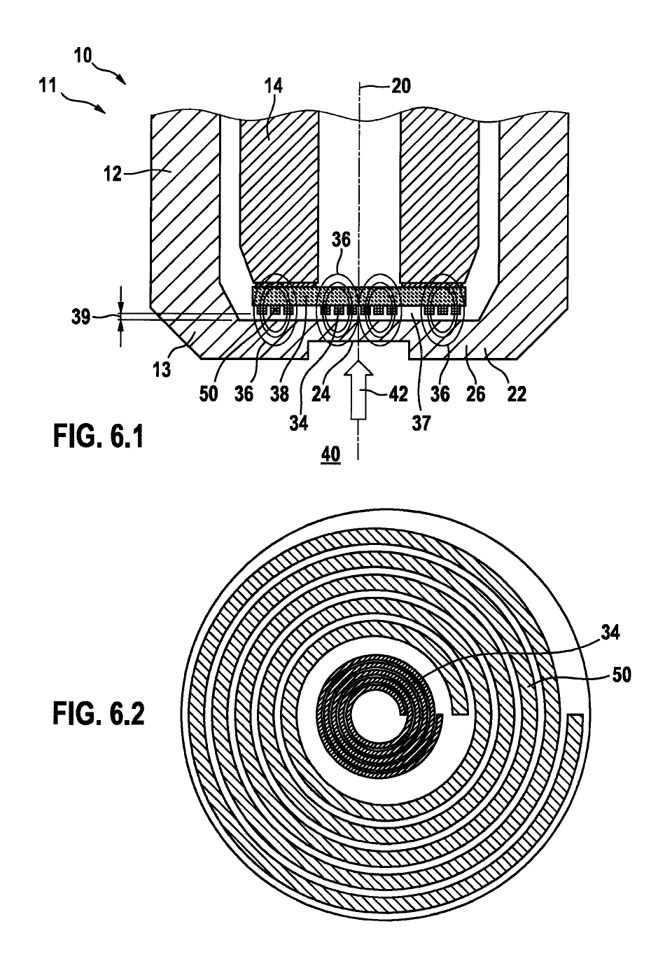

FIG. 6.1 schematically shows a third specific embodiment of combustion chamber pressure sensor 11 according to the present invention, which is accommodated in an engine mounting component 10. A sensor carrier 14 is accommodated centrally in an essentially cylindrical housing 12. Housing 12 has a cone 13 at an end facing combustion chamber 40, this cone being configured in one piece with a diaphragm 22. Furthermore, a measuring section 24 having a reduced thickness is provided centrally in diaphragm 22 in the area of main axis 20. In addition, a ceramic substrate 38 is mounted at the end of sensor carrier 14 facing the combustion chamber. A first coil 34 and a second coil 50 are situated around main axis 20 on ceramic substrate 38. First coil 34 is enclosed by second coil 50 and is situated opposite measuring section 24 of diaphragm 22. Diaphragm 22 and its measuring section 24 are manufactured from an electrically conductive material, such as steel, measuring section 24 being deformed by a compressive force 42 in the combustion chamber during operation. In addition, a magnetic field 36 is generated by first coil 34 which is influenced by a deformation of measuring section 24. First coil 34 thus implements the principle of an eddy current sensor, which detects clearance 39, in a noncontact operation, of a cavity 37 provided between first coil 34 and measuring section 24 of diaphragm 22.

Furthermore, second coil 50 is situated on substrate 38 radially on the outside and encloses first coil 34. Second coil 50 is situated opposite a fastening section 26 of diaphragm 22, which has a greater thickness than measuring section 24. Second coil 50 generates a magnetic field 36, which is influenced by clearance 39 between second coil 50 and fastening section 26 of diaphragm 22. The changes in clearance 39 in the fastening area of second coil 50 are detected. Second coil 50 implements the principle of an eddy current sensor, which allows a noncontact distance measurement. Due to the greater thickness of the material in fastening section 26 than in measuring section 24, only minor changes occur in clearance 39 of cavity 37 as a result of compressive forces 42. Second coil 50 detects changes in clearance 39 of cavity 37 caused by differences in thermal expansion of sensor carrier 14 and housing 12. The distances from measuring section 24 and fastening section 26 ascertained with the aid of first coil 34 and second coil 50 thus allow compensation of thermal expansion effects in combustion chamber pressure sensor 11 and ensure a high measuring accuracy in a wide range of application conditions.

FIG. 6.2 schematically shows a top view of an arrangement of a first coil 34 and a second coil 50 in a combustion chamber pressure sensor 11 according to FIG. 6.1. First coil 34 and second coil 50 are situated concentrically, second coil 50 enclosing first coil 34.

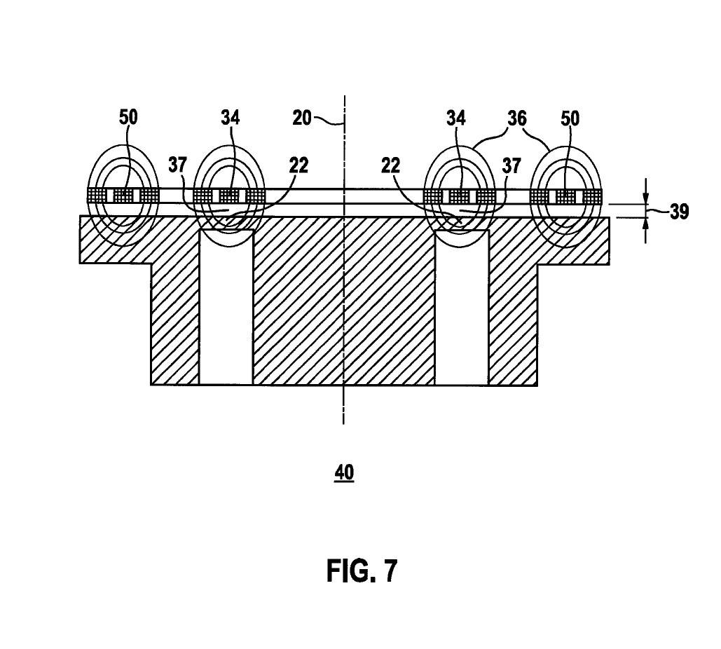

FIG. 7 schematically shows a fourth specific embodiment of the combustion chamber pressure sensor provided according to the present invention. In the combustion chamber pressure sensor according to FIG. 7, the pressure prevailing in combustion chamber 40 acts upon a separate sealing diaphragm (not shown) close to the combustion chamber. The compressive forces acting on the separate sealing diaphragm (not shown) proximal to the combustion chamber are transmitted mechanically to a diaphragm 22 via a plunger (not shown). A first coil 34 and a second coil 50 are situated concentrically around a main axis 20, which each generate a magnetic field 36. The plunger (not shown) is situated along main axis 20. Furthermore, diaphragm 22, which is manufactured from an electrically conductive material, is situated opposite first coil 34. Diaphragm 22 is configured in the form of a ring and is separated from coils 34, 50 by a cavity 37 having a clearance 39. Coils 34, 50 each implement the principle of an eddy current sensor, with which clearance 39 of cavity 37 is measured along main axis 20. Coil 50 functions to compensate for interfering influences acting upon the combustion chamber pressure sensor. Interfering influences may include distance changes between the diaphragm and first coil 34 which are not caused by compressive forces occurring in combustion chamber 40. Such interfering influences may be temperature changes in particular.

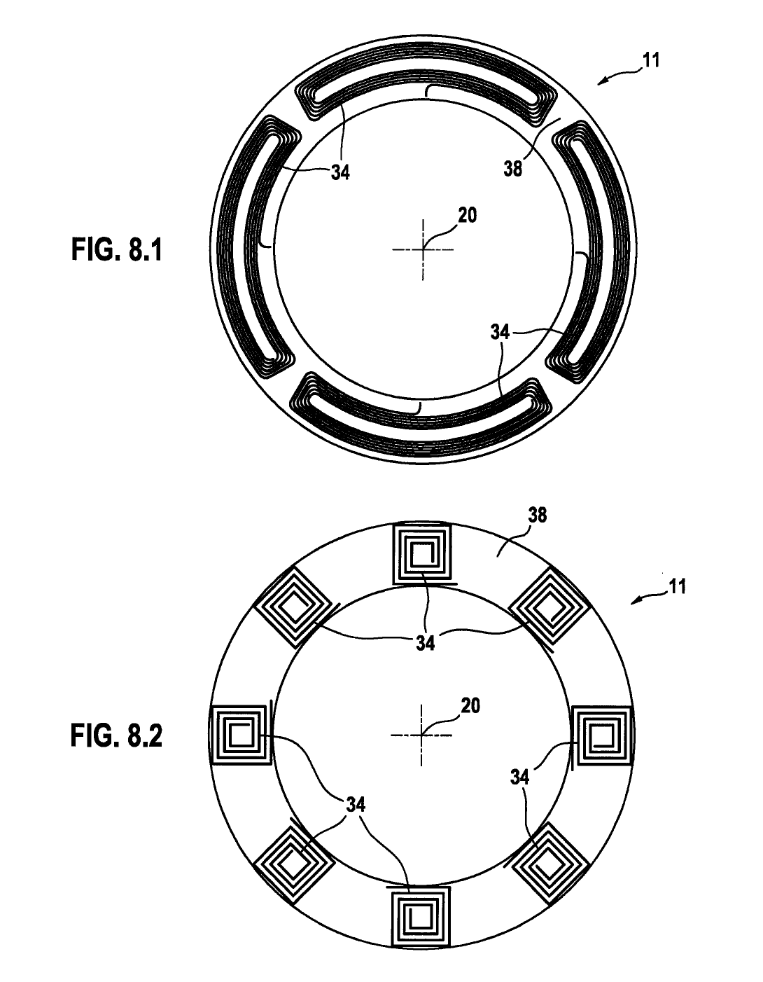

FIG. 8.1 shows a first specific embodiment of an arrangement of multiple first coils 34 which are mounted on a substrate 38. The four first coils 34 according to FIG. 8.1 are situated in a ring uniformly around main axis 20 and thereby ensure a redundant design of combustion chamber pressure sensor 11 which is not shown in greater detail. Each of first coils 34 is configured to be planar and has essentially a curved segment shape.

FIG. 8.2 shows a second specific embodiment of an arrangement of multiple first coils 34 which are mounted on a substrate 38. The eight first coils 34 according to FIG. 8.1 are situated in a ring uniformly around main axis 20 and thereby ensure a redundant design of combustion chamber pressure sensor 11, which is not shown in greater detail. Each of first coils 34 is configured to be planar and essentially rectangular.

1-13. (canceled)

14. A combustion chamber pressure sensor in an engine mounting component, comprising:
a combustion chamber pressure sensor arrangement having a sensor carrier, which is accommodated in a housing, a pressure sensor element, including a diaphragm, situated at an end of the sensor carrier facing the combustion chamber;
wherein the pressure sensor element includes an eddy current sensor, which includes at least one first solenoid coil.

15. The combustion chamber pressure sensor of claim 14, wherein an axial distance is in a cavity between the at least one first solenoid coil and the diaphragm.

16. The combustion chamber pressure sensor of claim 14, wherein a thermally insulating substrate is situated between the sensor carrier and the at least one first solenoid coil.

17. The combustion chamber pressure sensor of claim 16, wherein the thermally insulating substrate is manufactured from a ceramic material or a circuit board material or PCB.

18. The combustion chamber pressure sensor of claim 14, wherein the diaphragm is manufactured from an electrically conductive or ferromagnetic material.

19. The combustion chamber pressure sensor of claim 14, wherein the at least one first solenoid coil is configured in a rectangular, polygonal, planar or ring shape or in levels situated one upon another.

20. The combustion chamber pressure sensor of claim 14, wherein at least one second solenoid coil is situated on the sensor carrier.

21. The combustion chamber pressure sensor of claim 20, wherein the at least one first solenoid coil and the at least one second solenoid coil are situated concentrically around a main axis of the housing.

22. The combustion chamber pressure sensor of claim 20, wherein the at least one first solenoid coil and the at least one second solenoid coil are situated at an axial distance from one another.

23. The combustion chamber pressure sensor of claim 22, wherein a separating layer is between the at least one first solenoid coil and the at least one second solenoid coil.

24. The combustion chamber pressure sensor of claim 14, wherein the pressure sensor element includes a circuit board having at least one first solenoid coil.

25. A glow plug in an internal combustion engine, comprising:
a glow plug arrangement including a combustion chamber pressure sensor in an engine mounting component, the sensor including:
a combustion chamber pressure sensor arrangement having a sensor carrier, which is accommodated in a housing, a pressure sensor element, including a diaphragm, situated at an end of the sensor carrier facing the combustion chamber;
wherein the pressure sensor element includes an eddy current sensor, which includes at least one first solenoid coil.

26. A sparkplug in an internal combustion engine, comprising:
a sparkplug arrangement including a combustion chamber pressure sensor in an engine mounting component, the sensor including:
a combustion chamber pressure sensor arrangement having a sensor carrier, which is accommodated in a housing, a pressure sensor element, including a diaphragm, situated at an end of the sensor carrier facing the combustion chamber;
wherein the pressure sensor element includes an eddy current sensor, which includes at least one first solenoid coil.
